(19) United States
(12) Patent Application Publication
(10) Pub. No.: US 2010/0199018 A1
(43) Pub. Date: Aug. 5, 2010

(54) DATA TRANSFER SYSTEM, DATA TRANSMITTING APPARATUS, DATA RECEIVING APPARATUS, AND DATA TRANSFER METHOD

(75) Inventor: Daisuke HARADA, Kawasaki-shi (JP)

Correspondence Address: Fujitsu Patent Center;Fujitsu Management Services of America, Inc., 2318 Mill Road, Suite 1010, Alexandria, VA, 22314, US

(73) Assignee: FUJITSU LIMITED, Kawasaki-shi (JP)

(21) Appl. No.: 12/698,867

(22) Filed: Feb. 2, 2010

(30) Foreign Application Priority Data
Feb. 3, 2009 (JP) 2009-023040

(51) Int. Cl. G06F 13/00; G06F 11/30

(52) U.S. Cl. 710/316; 714/48; 714/E11.024

(57) ABSTRACT

A data transfer system transmitting and receiving data through a first transmission path and a second transmission path, the data transferring system includes a first apparatus that transmits data through the first transmission path and a second apparatus that receives the data from the first apparatus through the first transmission path, the second apparatus transmits error bit information about the bit position of an error, wherein when the first apparatus receives the error bit information from the second apparatus, the first apparatus transmits switching bit information concerning the bit position which is identified by the error bit information and the transmission path of which is switched to the second transmission path and the data on the bit position identified by the error bit information to the second apparatus through the second transmission path, and the second apparatus receives the data on the bit position identified by the switching bit information.

### CROSS-REFERENCE TO RELATED APPLICATIONS

This application is based upon and claims priority to prior Japanese Patent Application No. 2009-23040 filed on Feb. 3, 2009 in the Japan Patent Office, the entire contents of which are incorporated herein by reference.

### FIELD

Embodiments as described herein relate to a data transfer system, data transmitting apparatus, data receiving apparatus, and data transfer method.

### BACKGROUND

In recent years, apparatuses in which multiple central processing units (CPUs) and high-capacity memories are mounted on one substrate are provided with the progress in semiconductor technologies and Large Scale Integrated Circuit (LSI) mounting technologies. Such apparatuses include, for example, blade servers.

In such an apparatus, it is difficult to arrange the signal wirings between LSIs in substantially the same conditions, for example, to make all the signal wirings between LSIs substantially equal length because of mounting problems. Accordingly, variations in the transmission time of transmitting data from a data transmission side LSI to a data reception side LSI and variations in the wiring capacity arise between the bits on transmission signal wirings between LSIs.

For example, skew or jitter is specifically known as such a variation.

The variation mainly depends on, for example, characteristics of signal wirings functioning as the transmission paths on the board on which LSIs are mounted, the distance between the LSIs, the electric characteristics of connectors, and the signal drivability of the LSI chips. The variation becomes non-negligible with the increasing data transmission speed in recent years. Specifically, the variation makes the transmission with a higher reliability difficult.

Accordingly, in recent years, in addition to signal wiring serving as a first transmission path used for the data transfer between LSIs, redundant signal wiring serving as a second transmission path is generally provided in order to realize the transmission with a higher reliability.

For example, (1) data transfer by using the redundant signal wiring to perform error detection-correction with a function of, for example, parity or error check and correction (ECC)/cyclic redundancy check (CRC) or (2) data transfer in which the transmission path is duplicated is adopted.

Which data transfer method is used is based on the tradeoff between the reliability and the cost. Specifically, a larger amount of redundant wiring is preferable for the data transfer and the cost is increased in order to improve the reliability.

FIG. 12 illustrates an example of a data transfer process between LSIs in related art. In the example in FIG. 12, N+1-bit data (data D[0] to D[N]) is transmitted from a transmission LSI 1210 to a reception LSI 1220.

In the transmission LSI 1210, which is the data transmission side LSI, a data transmitter 1211 supplies the data D[0] to be transferred to a flip-flop (FF) 1212-0. The FF 1212-0 supplies the data D[0] to a driver 1213-0 in synchronization with a clock signal CLK.

The driver 1213-0 transmits the data D[0] to a receiver 1223-0 in the reception LSI 1220, which is the data reception side LSI, through a data signal line 0. A driver 1214 transmits the CLK to a receiver 1224 through a clock line.

The receiver 1223-0 supplies the received data D[0] to an FF 1222-0. The FF 1222-0 supplies the data D[0] to an error detection circuit 1225 in synchronization with the clock signal CLK supplied from the receiver 1224. The error detection circuit 1225 supplies the data D[0] to a data receiver 1221.

The data D[1] to D[N] are also transmitted from the transmission LSI 1210 to the reception LSI 1220 in substantially the same manner.

The data lines 0 to N and the clock line run on the boards having the transmission LSI 1210 and the reception LSI 1220 mounted thereon and run through connectors to connect the LSIs. Accordingly, the data signal wirings 0 to N and the clock line can be affected by, for example, various noises.

The error detection circuit 1225 confirms whether the data D[0] to D[N] transmitted from the transmission LSI 1210 have been normally received. If an error is detected, the error detection circuit 1225 notifies information of the bit where the error has occurred to the data receiver 1221, etc.

Part or all of the data D[0] to D[N] received by the reception LSI 1220 are hereinafter referred to as “received data”.

FIG. 13 is a flowchart illustrating an exemplary operation or state of the reception LSI 1220.

Referring to FIG. 13, when the transmission LSI 1210 and the reception LSI 1220 are turned on, at S1301, the transmission LSI 1210 and the reception LSI 1220 normally start the data transfer process between the transmission LSI 1210 and the reception LSI 1220.

At S1302, the error detection circuit 1225 detects a one-bit error in the received data. At S1303, the error detection circuit 1225 uses a one-bit error correction function to correct the one-bit error.

At S1304, the error detection circuit 1225 detects a new one-bit error. In this case, the error detection circuit 1225 cannot restore the received data in which the one-bit error has occurred to normal data because of the limitation of the error correction function. Accordingly, in Step S1305, the reliability of the data transferred between the transmission LSI 1210 and the reception LSI 1220 is reduced.

As a result, at S1306, the data transfer between the transmission LSI 1210 and the reception LSI 1220 is stopped. At S1307, the operation of the entire information processing system including the transmission LSI 1210 and the reception LSI 1220 is stopped.

[Patent Document 1] Japanese Laid-Open Patent Publication No. 05-268339

[Patent Document 2] Japanese Laid-Open Patent Publication No. 2000-078166

### SUMMARY

According to an aspect of the invention, there is provided a data transfer system transmitting and receiving data through a first transmission path and a second transmission path, the data transferring system includes a first apparatus that transmits data through the first transmission path and a second apparatus that receives the data from the first apparatus through the first transmission path, the second apparatus transmits error bit information about the bit position of an error, wherein when the first apparatus receives the error bit information from the second apparatus, the first apparatus transmits switching bit information concerning the bit position which is identified by the error bit information and the transmission path of which is switched to the second transmission path and the data on the bit position identified by the error bit information to the second apparatus through the second transmission path, and the second apparatus receives the data on the bit position identified by the switching bit information.

It is to be understood that both the foregoing summary description and the following detailed description are exemplary and explanatory and are not restrictive of the invention, as claimed.

### BRIEF DESCRIPTION OF THE DRAWINGS

FIG. 1 illustrates an example of the configuration of the main part of a data transfer system realizing a data transfer method according to an embodiment of the present invention;

FIG. 2 illustrates a specific example of the configuration of a selection circuit according to an embodiment;

FIG. 3 illustrates a specific example of the configuration of an error detection-switching circuit according to an embodiment;

FIG. 4 illustrates a specific example of the configuration of an error bit notification-switching determination circuit according to an embodiment;

FIG. 5 is a flowchart illustrating the outline of a process of switching to a spare line according to an embodiment;

FIG. 6 is a flowchart illustrating an example of a process of switching to the spare line in a reception LSI according to an embodiment;

FIG. 7 is a flowchart illustrating an example of a process of switching to the spare line in a transmission LSI according to an embodiment;

FIG. 8 is a time chart of the main signals when the number of error occurrences of transmission data exceeds a line switching threshold value;

FIG. 9 illustrates a modification of the configuration realizing the data transfer method according to an embodiment;

FIG. 10 illustrates a specific example of the configuration of a selection circuit when multiple spare lines are used;

FIG. 11 illustrates a specific example of the configuration of an error detection-switching circuit when multiple spare lines are used;

FIG. 12 illustrates an example of a data transfer process between LSIs in a related art; and

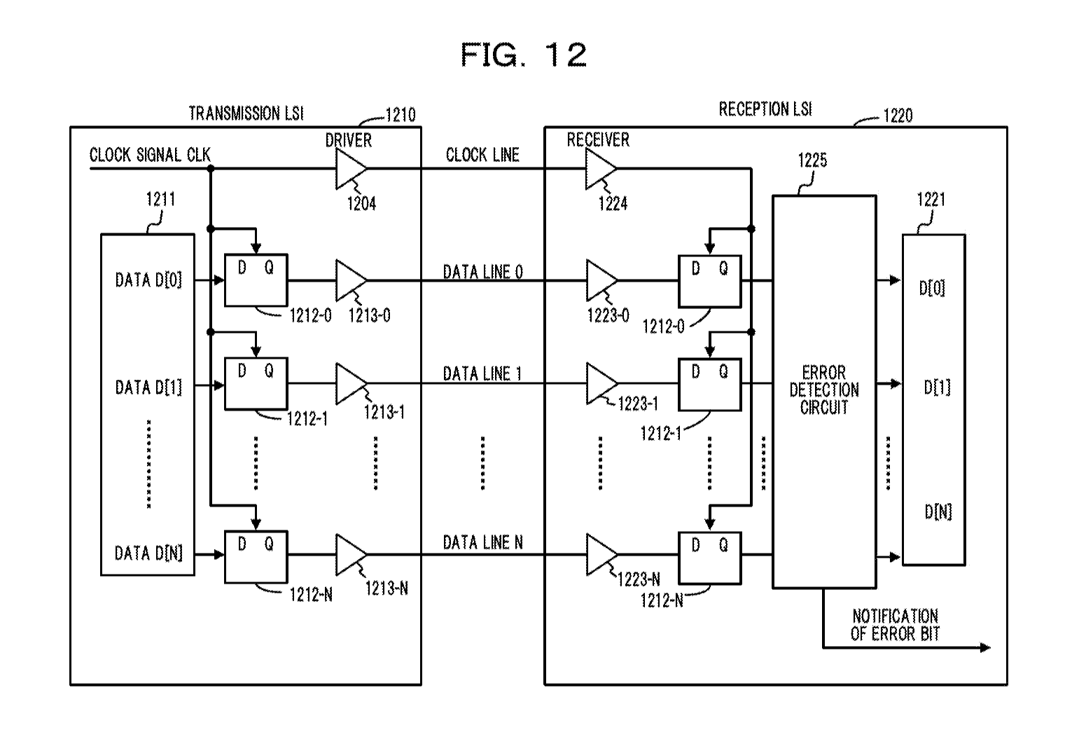

FIG. 13 is a flowchart illustrating an exemplary operation or state of a reception LSI in FIG. 12.

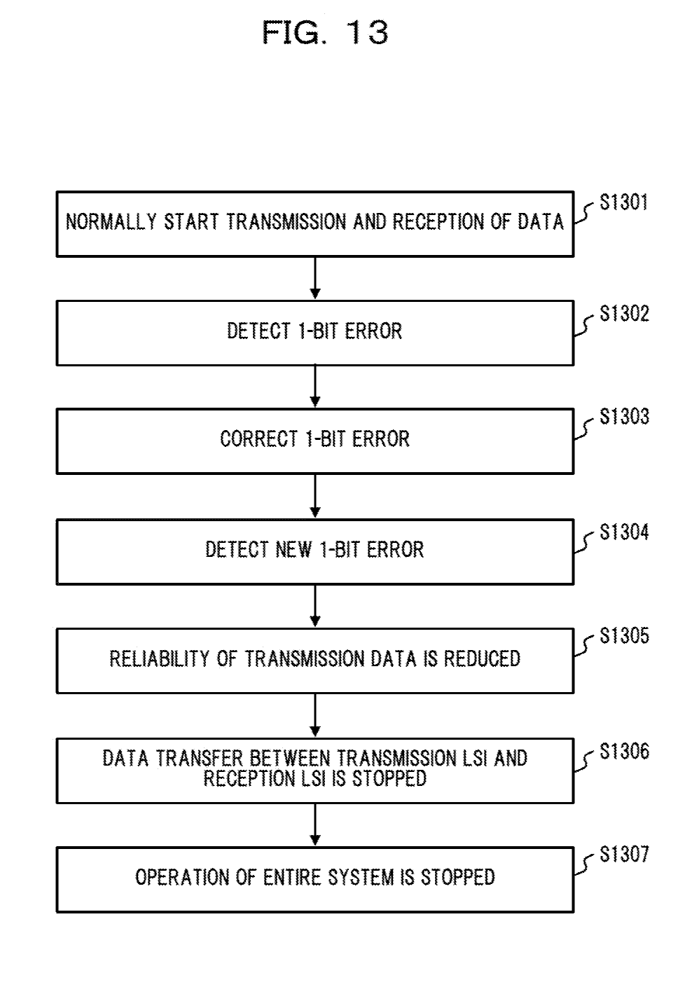

### DESCRIPTION OF EMBODIMENTS

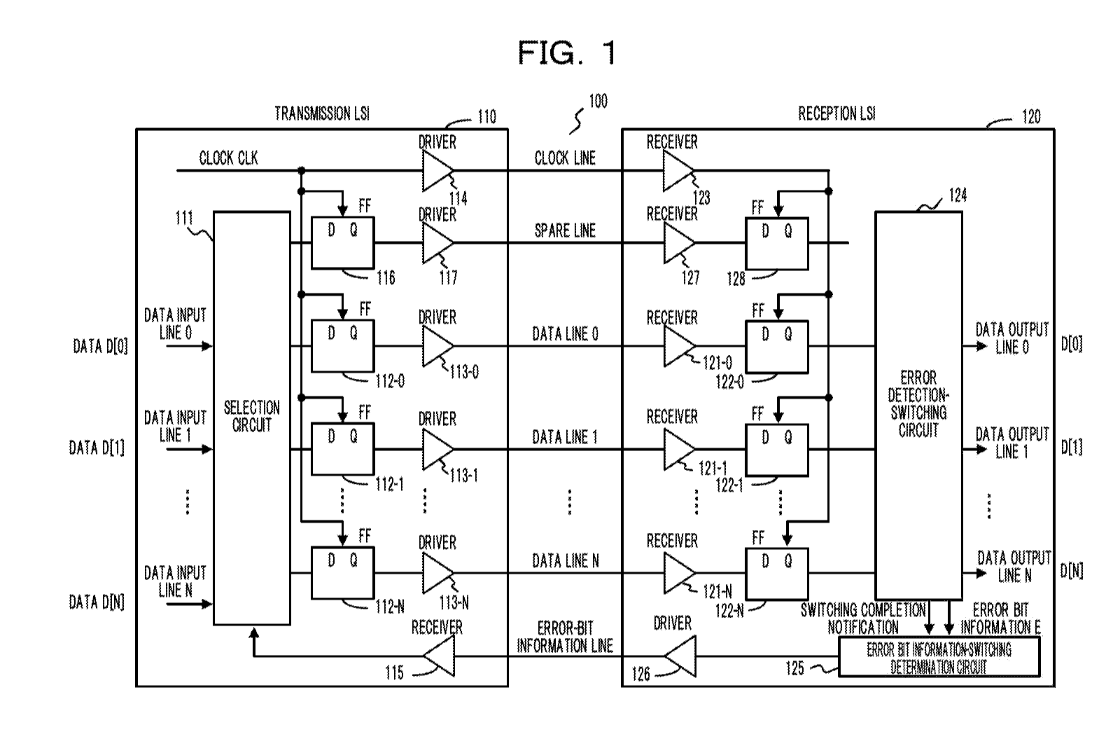

FIG. 1 illustrates an example of the configuration of a data transfer system 100 realizing a data transfer method according to an embodiment.

The data transfer system 100 includes a transmission LSI 110 transmitting N+1-bit data D composed of a plurality of one-bit-width data D[0]to D[N] and a reception LSI 120 receiving the data D transmitted from transmission LSI 110.

The data composed of the data D[0] to D[N] is hereinafter referred to as the “data D.” The figures in square brackets of the data D[0] to D[N] represent the bit positions in the data D. For example, the data D[0] represents data at a bit 0 of the data D. “N” denotes a natural number including zero.

The transmission LSI 110 is connected to the reception LSI 120 so as to be capable of communicating with the reception LSI 120 via data lines 0, 1, . . . , and N, a spare line, a clock line, and an error-bit information line.

The data lines 0, 1, . . . , and N are used to transmit the data D[0], D[1], . . . , and D[N]. The spare line is provided for a spare of the data lines and is used to transmit one-bit-width data. The clock line is used to transmit a clock signal CLK. The error-bit information line is used to transmit, for example, error bit information E described below.

The transmission LSI 110 includes a selection circuit 111, flip-flops (FFs) 112-0 to 112-N, drivers 113-0 to 113-N, a driver 114, a receiver 115, an FF 116, and a driver 117.

The selection circuit 111 is connected to data input lines 0, 1, . . . , and N that are connected to another LSI or the like. The output terminal of the selection circuit 111 is connected to the FFs 112-0, 112-1, . . . , and 112-N and the FF 116. The output terminal of a clock-signal generation circuit (not illustrated) generating the clock signal CLK is also connected to the FFs 112-0, 112-1, . . . , and 112-N and the FF 116.

The output terminals of the FFs 112-0, 112-1, . . . , and 112-N and the FF 116 are connected to the drivers 113-0, 113-1, . . . , and 113-N and the driver 117, respectively.

The output terminals of the drivers 113-0, 113-1, . . . , and 113-N, the driver 114, and the driver 117 are connected to the data lines 0, 1, . . . , and N, the clock line, and the spare line, respectively.

The driver 114 is connected to the output terminal of the clock-signal generation circuit (not illustrated).

The output terminal of the receiver 115 is connected to the selection circuit 111. The receiver 115 is also connected to the error-bit information line.

The reception LSI 120 includes receivers 121-0 to 121-N, FFs 122-0 to 122-N, a receiver 123, an error detection-switching circuit 124, an error bit notification-switching determination circuit 125, a driver 126, a receiver 127, and an FF 128.

The receivers 121-0, 121-1, . . . , and 121-N, the receiver 123, and the receiver 127 are connected to the data lines 0, 1, . . . , and N, the clock line, and the spare line, respectively.

The output terminals of the receivers 121-0, 121-1, . . . , and 121-N and the receiver 127 are connected to the FFs 122-0, 122-1, . . . , and 122-N and the FF 128, respectively.

The output terminals of the FFs 122-0, 122-1, . . . , and 122-N are connected to the error detection-switching circuit 124. The error detection-switching circuit 124 is connected to data output lines 0, 1, . . . , and N that are connected to another LSI or the like.

The output terminal of the receiver 123 is connected to the FFs 122-0, 122-1, . . . , and 122-N and the FF 128.

Among the output terminals of the error detection-switching circuit 124, the output terminals through which the data D is outputted are connected to the other LSI or the like connected to the reception LSI 120. Among the output terminals of the error detection-switching circuit 124, the output terminals through which the error bit information E and a switching completion notification are outputted are connected to the error bit notification-switching determination circuit 125.

The output terminal of the error bit notification-switching determination circuit 125 is connected to the driver 126. The output terminal of the driver 126 is connected to the error-bit information line.

The transmission LSI 110 having the above configuration performs a data transmitting process described below.

The selection circuit 111 receives the N+1-bit data D[0] to D[N] transmitted from the other LSI or the like. For example, the selection circuit 111 supplies the received data D[0] to the FF 112-0.

The FF 122-0 holds the data D[0] received from the selection circuit 111. The FF 122-0 supplies the data D[0] to the driver 113-0 in synchronization with the clock signal CLK.

The driver 113-0 transmits the data D[0] supplied from the FF 112-0 to the receiver 121-0 through the data line 0.

The transmission LSI 110 transmits the data D[0] to the reception LSI 120 through the above operation.

The transmission LSI 110 transmits the data D[1], D[2], . . . , and D[N] to the receiver 121-1, 121-2, . . . , and 121-N, respectively, through similar operations.

For example, the selection circuit 111 supplies the data D[N] to the FF 112-N. The FF 122-N holds the data D[N] received from the selection circuit 111. The FF 122-N supplies the data D[N] to the driver 113-N in synchronization with the clock signal CLK.

The driver 113-N transmits the data D[N] supplied from the FF 112-N to the receiver 121-N through the data line N.

The driver 114 transmits the clock signal CLK to the receiver 123 through the clock line.

The reception LSI 120 performs a data receiving process described below.

For example, the receiver 121-0 receives the data D[0] transmitted from the driver 113-0 through the data line 0. The receiver 121-0 supplies the received data D[0] to the FF 122-0. The FF 122-0 holds the data D[0] supplied from the receiver 121-0.

The receiver 123 supplies the clock signal CLK transmitted through the clock line to the FFs 122-0, 122-1, . . . , and 122-N and the FF 128.

The FF 122-0 supplies the data D[0] to the error detection-switching circuit 124 in synchronization with the clock signal CLK supplied from the receiver 123.

The reception LSI 120 receives the data D[0] transmitted from the transmission LSI 110 through the above operation.

The reception LSI 120 receives the data D[1], D[2], . . . , and D[N] transmitted from the transmission LSI 110 through similar operations.

For example, the receiver 121-N receives the data N[N] transmitted from the driver 113-N through the data line N. The receiver 121-N supplies the received data D[N] to the FF 122-N.

The FF 122-N holds the data D[N] supplied from the receiver 121-N. The FF 122-N supplies the data D[N] to the error detection-switching circuit 124 in synchronization with the clock signal CLK supplied from the receiver 123.

The error detection-switching circuit 124 determines whether an error occurred in the N+1-bit data D composed of the one-bit-width data D[0] to D[N]. The error detection-switching circuit 124 counts the number of error occurrences for every bit.

The bit in which an error has occurred is called an error bit. A case in which the error bit is “i” will be described, where “i” denotes a natural number that includes zero and is not larger than N.

The error detection-switching circuit 124 determines whether an error occurred in the data D by using, for example, the parity or the ECC/CRC function.

If no error is detected, the error detection-switching circuit 124 outputs the data D of each bit to the data output lines 0, 1, . . . , and N.

If an error is detected, the error detection-switching circuit 124 generates the error bit information E and notifies the error bit notification-switching determination circuit 125 of the error bit information E. Here, the error detection-switching circuit 124 may output the data D of each bit to the data output lines 0, 1, . . . , and N.

The “error bit information E” indicates information identifying the error bit in the data D detected by the error detection-switching circuit 124.

Upon the reception of the notification of the error bit information E from the error detection-switching circuit 124, the error bit notification-switching determination circuit 125 counts the number of error occurrences at the error bit. For example, if an error has occurred in the data D[i], the error bit notification-switching determination circuit 125 counts and stores the number of error occurrences at the bit i.

If the number of error occurrences at the error bit i is larger than or equal to a predetermined value, the error bit notification-switching determination circuit 125 encodes the error bit information E into serial data and supplies the encoded error bit information E to the driver 126.

The driver 126 transmits the error bit information E to the receiver 115 through the error-bit information line. The receiver 115 supplies the error bit information E transmitted from the driver 126 to the selection circuit 111.

Upon the reception of the error bit information E from the receiver 115, the selection circuit 111 decodes the error bit information E in the serial data to identify the error bit i. The selection circuit 111 switches the destination of the data D[i] at the error bit i from the FF 112-i to the FF 116.

At substantially the same time, the selection circuit 111 generates switching bit information and supplies the switching bit information to the FF 116. The “switching bit information” concerns the bit position in the data D identifying the bit having a destination which is switched to the FF 116 via the spare line. Accordingly, when the error bit information indicates “i”, the switching bit information also indicates “i”.

Then, the selection circuit 111 supplies the data D[0], D[1], . . . , and D[N] received from the other LSI or the like to the FFs 112-0, 112-1, . . . , and 112-N, respectively. However, the selection circuit 111 supplies only the data D[i] to the FF 116.

The FF 116 holds the switching bit information supplied from the selection circuit 111. The FF 116 supplies the switching bit information to the driver 117 in synchronization with the clock signal CLK. The driver 117 transmits the switching bit information to the receiver 127 through the spare line.

Upon the reception of the switching bit information from the driver 117, the receiver 127 supplies the switching bit information to the FF 128. The FF 128 holds the switching bit information. The FF 128 supplies the switching bit information to the error detection-switching circuit 124 in synchronization with the clock signal CLK supplied from the receiver 123.

The data D[i] is transmitted from the selection circuit 111 to the error detection-switching circuit 124 in a process similar to that for the switching bit information. The data D excluding the data D[i] is transferred in the manner described above.

Upon the reception of the switching bit information from the FF 128, the error detection-switching circuit 124 switches the data line i through which the data D[i] at the bit i identified by the switching bit information is transferred to the spare line. Then, the error detection-switching circuit 124 supplies the switching completion notification to the error bit notification-switching determination circuit 125.

The error bit notification-switching determination circuit 125 supplies the received switching completion notification to the driver 126. The driver 126 transmits the switching completion notification to the receiver 115 through the error-bit information line.

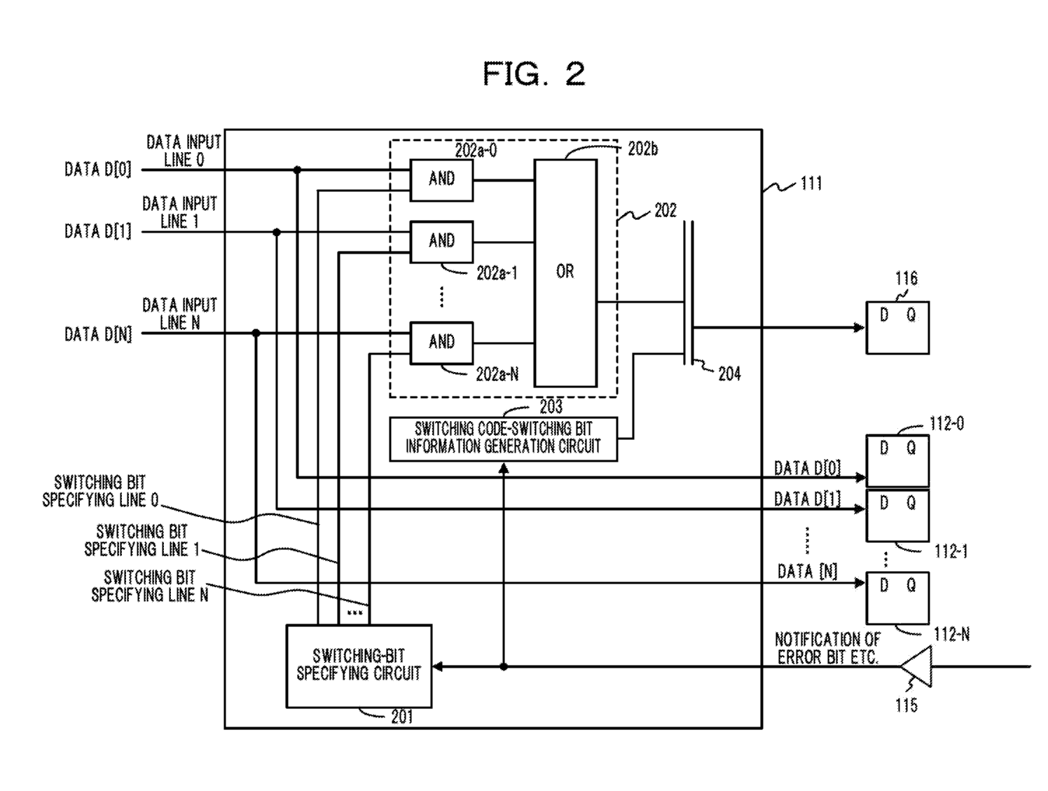

FIG. 2 illustrates a specific example of the configuration of the selection circuit 111 according to one embodiment.

The selection circuit 111 includes a switching-bit specifying circuit 201, a switching-signal selection circuit 202, a switching code-switching bit information generation circuit 203, and a selector 204.

The switching-signal selection circuit 202 includes AND circuits 202a-0, 202a-1, . . . , and 202a-N and an OR circuit 202b.

The switching-bit specifying circuit 201 and the switching code-switching bit information generation circuit 203 are connected to the output terminal of the receiver 115.

The data input lines 0, 1, . . . , and N are connected to the AND circuits 202a-0, 202a-1, . . . , and 202a-N, respectively. The data input lines 0, 1, . . . , and N are also connected to the FFs 112-0, 112-1, . . . , and 112-N, respectively.

One end of each of switching bit specifying lines 0, 1, . . . , and N described below is connected to the switching-bit specifying circuit 201. The other ends of the switching bit specifying lines 0, 1, . . . , and N are connected to the AND circuits 202a-0, 202a-1, . . . , and 202a-N, respectively.

The output terminals of the AND circuits 202a-0, 202a-1, . . . , and 202a-N are connected to the OR circuit 202b. The output terminal of the OR circuit 202b and the output terminal of the switching code-switching bit information generation circuit 203 are connected to the selector 204. The output terminal of the selector 204 is connected to the FF 116.

In the above configuration, if the switching-bit specifying circuit 201 detects an error occurrence code described below, the switching-bit specifying circuit 201 receives the error bit information E from the receiver 115 which is transmitted from the error bit notification-switching determination circuit 125 after the error occurrence code is transmitted by the error bit notification-switching determination circuit 125.

Then, the switching-bit specifying circuit 201 decodes the error bit information E transmitted as the serial data to identify the error bit. The switching-bit specifying circuit 201 generates switching-bit specifying data S for specifying the data line to be switched to the spare line. The switching-bit specifying circuit 201 supplies the switching-bit specifying data S to the switching-signal selection circuit 202.

The switching-bit specifying data S has the same bit width as that of the data D received from the other LSI or the like. Since the data D according to one embodiment has a bit width of N+1 bit, the switching-bit specifying data S also has a bit width of N+1 bit. In other words, the switching-bit specifying data S is composed of a plurality of one-bit-width data S[0], S[1], . . . , and S[N]. The figures in square brackets of the one-bit-width data S[0], S[1], . . . , and S[N] represent the bit positions in the switching-bit specifying data S.

For example, when the error bit is “i”, the switching-bit specifying circuit 201 generates the switching-bit specifying data S in which only the data S[i] is set to “1” and the data S[0], S[1], . . . , and S[N] excluding the data S[i] are set to “0”.

The switching-bit specifying circuit 201 supplies the switching-bit specifying data S[0], S[1], . . . , and S[N] to the AND circuits 202a-0, 202a-1, . . . , and 202a-N, respectively.

In the switching-signal selection circuit 202, for example, the AND circuit 202a-0 supplies a result of the logical AND operation of the data D[0] supplied through the data input line 0 and the switching-bit specifying data S[0] supplied from the switching-bit specifying circuit 201 to the OR circuit 202b.

The remaining AND circuits 202a-1, 202a-2, . . . , and 202a-N supply the logical ANDs to the OR circuit 202b in similar processes, respectively.

For example, the AND circuit 202a-N supplies a result of the logical AND operation of the data D[N] supplied through the data input line N and the switching-bit specifying data S[N] supplied from the switching-bit specifying circuit 201 to the OR circuit 202b.

The OR circuit 202b supplies a result of the logical OR operation of the outputs from the AND circuits 202a-0, 202a-1, . . . , and 202a-N to the selector 204.

When the switching code-switching bit information generation circuit 203 detects the error occurrence code described below, the switching code-switching bit information generation circuit 203 receives the error bit information E from the receiver 115 which is transmitted from the error bit notification-switching determination circuit 125 after the error occurrence code is transmitted by the error bit notification-switching determination circuit 125.

Then, the switching code-switching bit information generation circuit 203 decodes the error bit information E transmitted as the serial data to identify the error bit. The switching code-switching bit information generation circuit 203 generates the switching bit information for specifying the data line to be switched to the spare line.

The switching code-switching bit information generation circuit 203 generates a switching code and encodes the switching bit information into serial data. The switching code-switching bit information generation circuit 203 supplies the switching code and the switching bit information to the selector 204. Here, the switching code-switching bit information generation circuit 203 outputs the switching bit information after the switching code is outputted by the switching code-switching bit information generation circuit 203.

The switching code is used for notifying the reception LSI 120 that one of the data lines is switched to the spare line. Accordingly, the switching code may be an arbitrary predetermined code as long as the switching code may be distinguished from other data.

When the output signal is received from the switching code-switching bit information generation circuit 203, the selector 204 selects the output signal from the switching code-switching bit information generation circuit 203 and supplies the selected output signal to the FF 116. When no output signal is received from the switching code-switching bit information generation circuit 203, the selector 204 supplies the output signal from the OR circuit 202b to the FF 116.

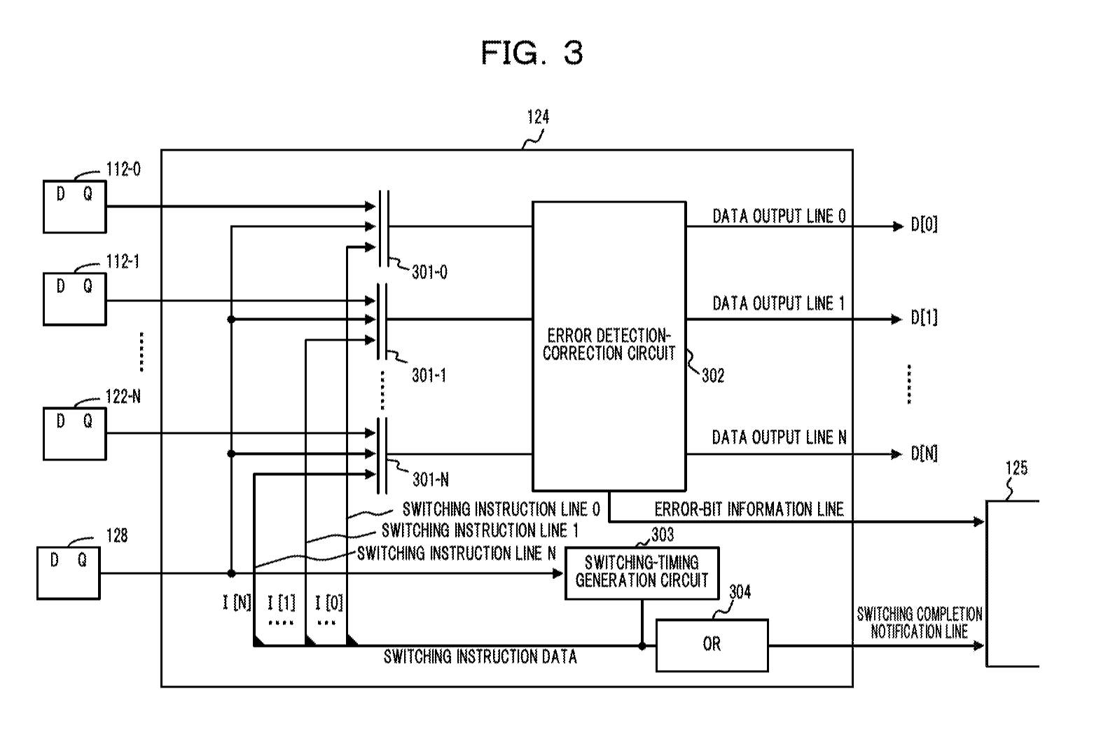

FIG. 3 illustrates a specific example of the configuration of the error detection-switching circuit 124 according to an embodiment.

The error detection-switching circuit 124 includes selectors 301-0 to 301-N, an error detection-correction circuit 302, a switching-timing generation circuit 303, and an OR circuit 304.

The output terminals of the FFs 122-0, 122-1, . . . , and 122-N are connected to the selectors 301-0, 301-2, . . . , and 301-N, respectively. The output terminal of the FF 128 is connected to the selectors 301-0, 301-1, . . . , and 301-N and the switching-timing generation circuit 303.

The output terminal of the switching-timing generation circuit 303 is connected to the selectors 301-0, 301-1, . . . , and 301-N. The output terminal of the switching-timing generation circuit 303 is also connected to the OR circuit 304.

One-bit-width data is transmitted through the lines connecting the switching-timing generation circuit 303 to the selectors 301-0, 301-1, . . . , and 301-N. The switching-timing generation circuit 303 supplies switching instruction data I[0], I[1], . . . , and I[N] described below to the selectors 301-0, 301-1, . . . , and 301-N, respectively.

The output terminals of the selectors 301-0, 301-1, . . . , and 301-N are connected to the error detection-correction circuit 302.

Among the output terminals of the error detection-correction circuit 302, the output terminals through which the data D is outputted are connected to the data output lines 0, 1, . . . , and N connected to the other LSI or the like (not illustrated).

The error-bit information line through which the error bit information E is outputted, among the output terminals of the error detection-correction circuit 302, is connected to the error bit notification-switching determination circuit 125.

The output terminal of the OR circuit 304 is connected to the error bit notification-switching determination circuit 125.

In the above configuration, for example, the selector 301-0 selects the output signal from the FF 128 if the switching instruction data I[0] supplied from the switching-timing generation circuit 303 is set to “1”. The selector 301-0 selects the output signal from the FF 122-0 if the switching instruction data I[0] is set to “0”. The selector 301-0 supplies the selected signal to the error detection-correction circuit 302.

The remaining selectors 301-1, 301-2, . . . , and 301-N perform similar operations. For example, the selector 301-N selects the output signal from the FF 128 if the switching instruction data I[N] is set to “1”. The selector 301-N selects the output signal from the FF 122-N if the switching instruction data I[N] is set to “0”. The selector 301-N supplies the selected signal to the error detection-correction circuit 302.

The error detection-correction circuit 302 receives the data D[0], D[1], . . . , and D[N] supplied from the selectors 301-0, 301-1, . . . , and 301-N, respectively. The error detection-correction circuit 302 performs an error checking process on the N+1-bit data D composed of the data D[0], D[1], . . . , and D[N].

For example, the error detection-correction circuit 302 performs the error checking process by using the parity or the ECC/CRC function.

If no error is detected, the error detection-correction circuit 302 supplies the data D of each bit to the data output lines 0, 1, . . . , and N. For example, the error detection-correction circuit 302 outputs the data D[0] to the data output line 0 and outputs the data D[1] to the data output line 1, respectively.

If an error is detected, the error detection-correction circuit 302 generates the N+1-bit error bit information E in which the error bit is set to “1” and the other bits are set to “0”. Accordingly, the error bit information E is composed of a plurality of one-bit-width data E[0], E[1], . . . , and E[N]. For example, the data E[0] that is set to “1” indicates that an error occurs in the data D[0].

After generating the error bit information E, the error detection-correction circuit 302 supplies the error bit information E to the error bit notification-switching determination circuit 125.

When the switching-timing generation circuit 303 detects the switching code from the output signal from the FF 128, the switching-timing generation circuit 303 acquires the switching bit information transmitted from the FF 118 after the switching code is transmitted from the FF 128.

After acquiring the switching bit information, the switching-timing generation circuit 303 generates the N+1-bit switching instruction data I in which the bit indicated in the switching bit information is set to “1” and the other bits are set to “0”. The switching instruction data I is composed of the one-bit-width data I[0], I[1], . . . , and I[N]. For example, the data I[0] that is set to “1” indicates that the data line 0 is to be switched to the spare line.

After generating the switching instruction data I, the switching-timing generation circuit 303 supplies the switching instruction data I of each bit to the selectors 301-0, 301-1, . . . , and 301-N, respectively. For example, the switching-timing generation circuit 303 supplies the switching instruction data I[0] to the selector 301-0, supplies the switching instruction data I[1] to the selector 301-1, . . . , and supplies the switching instruction data I[N] to the selector 301-N.

In addition, the switching-timing generation circuit 303 supplies the switching instruction data Ito the OR circuit 304. The OR circuit 304 supplies a result of the logical OR operation of the data I[0], I[1], . . . , and I[N] composing the switching instruction data I to the error bit notification-switching determination circuit 125. The logical OR output from the OR circuit 304 is used as the “switching completion notification”.

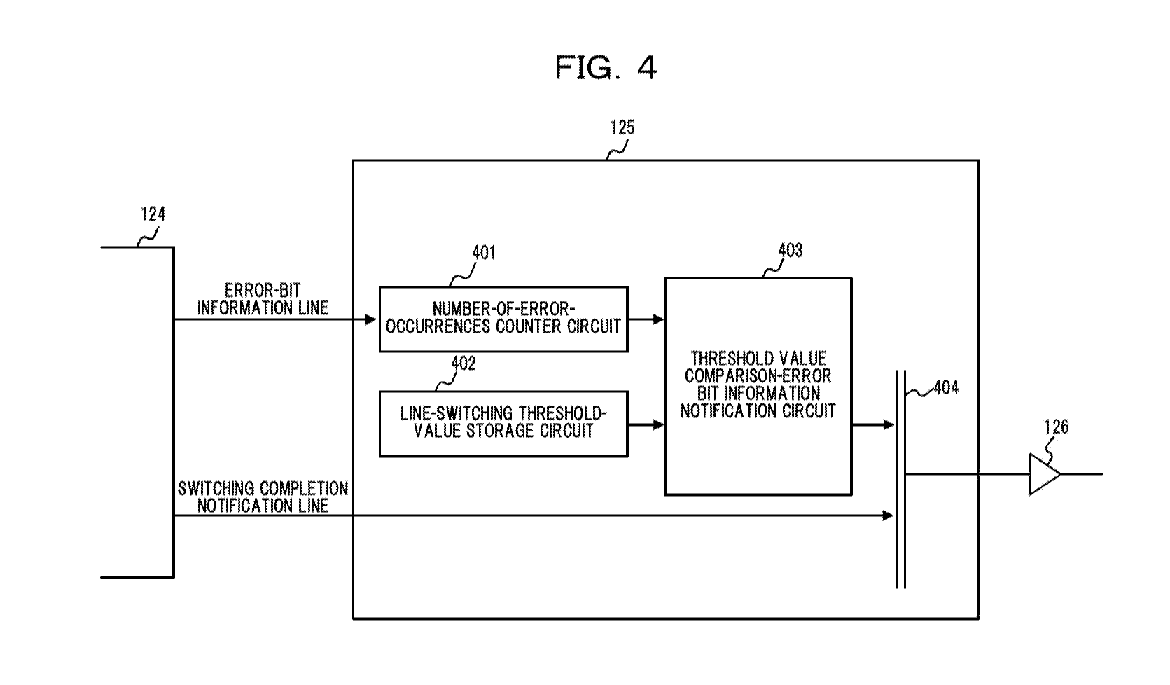

FIG. 4 illustrates a specific example of the configuration of the error bit notification-switching determination circuit 125 according to an embodiment.

The error bit notification-switching determination circuit 125 includes a number-of-error-occurrences counter circuit 401, a line-switching threshold-value storage circuit 402, a threshold value comparison-error bit information notification circuit 403, and a selector 404.

The number-of-error-occurrences counter circuit 401 is connected to the error detection-switching circuit 124 via the error-bit information line. The output terminal of the number-of-error-occurrences counter circuit 401 and the output terminal of the line-switching threshold-value storage circuit 402 are connected to the threshold value comparison-error bit information notification circuit 403, respectively.

The selector 404 connects the output terminal of the threshold value comparison-error bit information notification circuit 403 to a switching completion notification line used for notifying that the switching has been performed by the error detection-switching circuit 124.

In the above configuration, when the number-of-error-occurrences counter circuit 401 receives the error bit information E from the error detection-switching circuit 124, the number-of-error-occurrences counter circuit 401 refers to each bit of the error bit information E. The error detection-switching circuit 124 detects the bit that is set to “1” from the referred error bit information E to identify the error bit.

After identifying the error bit, the number-of-error-occurrences counter circuit 401 adds one to the number of error occurrences of the error bit stored in a number-of-error-occurrences storage part (not illustrated) provided in the number-of-error-occurrences counter circuit 401.

The number-of-error-occurrences counter circuit 401 notifies the threshold value comparison-error bit information notification circuit 403 of the error bit information E and the number of error occurrences.

Upon the reception of the notification of the number of error occurrences from the number-of-error-occurrences counter circuit 401, the threshold value comparison-error bit information notification circuit 403 receives a line switching threshold value from the line-switching threshold-value storage circuit 402. The line-switching threshold-value storage circuit 402 stores a threshold value used as a reference value in determination of whether the data line transferring data of a bit position where an error has occurred is to be switched to the spare line. This threshold value is called as “line switching threshold value”.

Then, the threshold value comparison-error bit information notification circuit 403 compares the number of error occurrences with the line switching threshold value. If the number of error occurrences is larger than or equal to the line switching threshold value, the threshold value comparison-error bit information notification circuit 403 generates the error occurrence code, encodes the error bit information E into serial data, and supplies the error occurrence code and the error bit information E to the selector 404.

The error occurrence code is used to indicate that errors have occurred in the transmission LSI 110 a number of times that is larger than or equal to the line switching threshold value. Accordingly, the error occurrence code may be an arbitrary predetermined code as long as the error occurrence code may be distinguished from other data.

After generating the error occurrence code, the threshold value comparison-error bit information notification circuit 403 outputs the switching bit information E subsequently to the error occurrence code.

Upon the reception of the output signal from the threshold value comparison-error bit information notification circuit 403, the selector 404 selects the output signal from the threshold value comparison-error bit information notification circuit 403. Accordingly, if the error occurrence code and the error bit information E are received from the threshold value comparison-error bit information notification circuit 403, the selector 404 supplies the error occurrence code and the error bit information E to the driver 126.

In addition, when the selector 404 receives the switching completion notification from the error detection-switching circuit 124, the selector 404 supplies the switching completion notification to the driver 126.

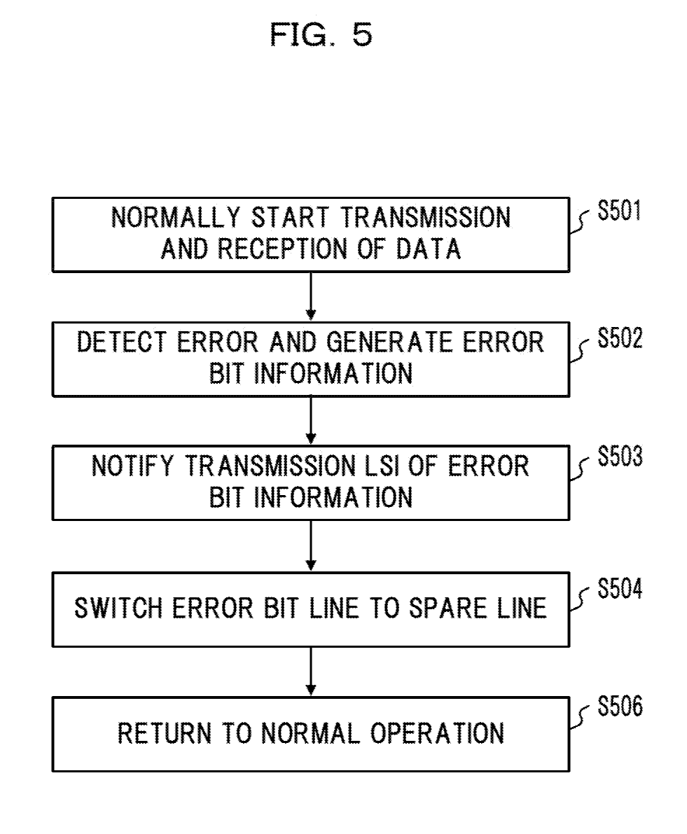

FIG. 5 is a flowchart illustrating the outline of a process of switching to the spare line according to an embodiment.

Referring to FIG. 5, for example, when the transmission LSI 110 and the reception LSI 120 are turned on, at S501, the transmission LSI 110 and the reception LSI 120 normally start the data transfer process between them.

At S502, when the reception LSI 120 detects the number of error occurrences larger than or equal to the line switching threshold value at a bit of the data transmitted from the transmission LSI 110, the reception LSI 120 generates the error bit information E.

At S503, the reception LSI 120 notifies the transmission LSI 110 of the error bit information E.

At S504, when the transmission LSI 110 receives the error bit information E from the reception LSI 120, the transmission LSI 110 switches an error bit line to the spare line. The error bit line indicates the data line where an error has occurred.

When the switching to the spare line is completed, at S506, the transmission LSI 110 and the reception LSI 120 restart the data transfer process between them.

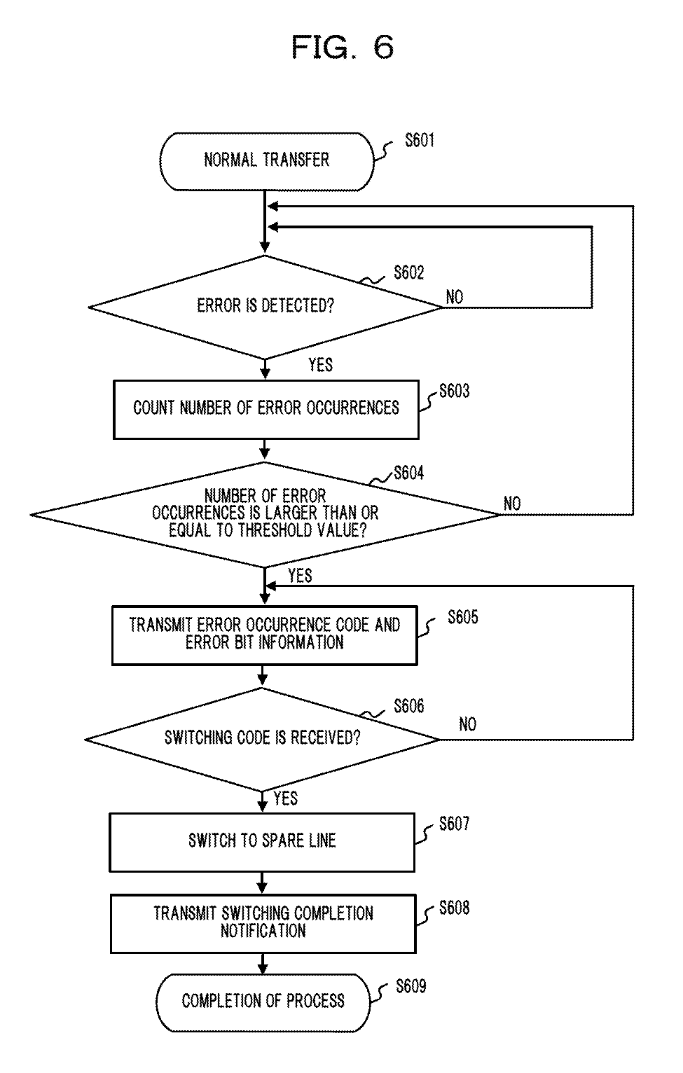

FIG. 6 is a flowchart illustrating an example of a process of switching to the spare line in the reception LSI 120 according to an embodiment.

Referring to FIG. 6, at S601, when the transmission LSI 110 and the reception LSI 120 are turned on, the transmission LSI 110 and the reception LSI 120 normally start the data transfer process between them.

At S602, the error detection-switching circuit 124 receives the data D from the transmission LSI 110 through the data lines 0, 1, . . . , N. Upon the reception of the data D transmitted from the transmission LSI 110 through the data lines 0, 1, . . . , N, the error detection-switching circuit 124 performs the error checking process on the data D to determine whether an error occurs on the data D.

At substantially the same time, the error detection-switching circuit 124 transmits the data D to the other LSI or the like connected to the reception LSI 120 through the data output lines 0, 1, . . . , and N.

If the error detection-switching circuit 124 detects no error (NO at S602), the error detection-switching circuit 124 repeats S602.

If the error detection-switching circuit 124 detects an error (YES at S602), the error detection-switching circuit 124 generates the error bit information E in which the bit where the error has occurred is set to “1” and the other bits are set to “0”. The error detection-switching circuit 124 supplies the generated error bit information E to the error bit notification-switching determination circuit 125.

When the transmission of the error bit information E is completed, the error detection-switching circuit 124 goes to S603.

At S603, the error bit notification-switching determination circuit 125 identifies the error bit from the received error bit information E. Then, the error bit notification-switching determination circuit 125 counts the number of error occurrences for every bit of the received error bit information E.

For example, the error bit notification-switching determination circuit 125 refers to the number of error occurrences for every bit, stored in the number-of-error-occurrences storage part in the error bit notification-switching determination circuit 125. The error bit notification-switching determination circuit 125 stores a value given by adding one to the number of error occurrences at the error bit in the number-of-error-occurrences storage part.

At S604, the error bit notification-switching determination circuit 125 compares the line switching threshold value with the number of error occurrences in the error bit information E. The line switching threshold value is set for each bit in advance.

If the number of error occurrences is smaller than the line switching threshold value (NO at S604), the error bit notification-switching determination circuit 125 goes back to S602. If the number of error occurrences is larger than or equal to the line switching threshold value (YES at S604), the error bit notification-switching determination circuit 125 goes to S605.

At S605, the error bit notification-switching determination circuit 125 generates the error occurrence code, which is set in advance. Then, the error bit notification-switching determination circuit 125 transmits the error occurrence code and the error bit information E to the transmission LSI 110 through the error-bit information line.

The error-bit information line according to an embodiment is a line thorough which one-bit-width data is transmitted. Accordingly, the error bit notification-switching determination circuit 125 encodes the error bit information E into serial data and supplies the encoded error bit information E to the driver 126, subsequently to the error occurrence code.

However, the error-bit information line is not limited to the line through which one-bit-width data is transmitted. For example, the error-bit information line may be a line through which N+1-bit-width data is transmitted.

At S606, the error detection-switching circuit 124 determines whether the switching code is received through the spare line.

If the switching code is not received through the spare line (NO at S606), the error detection-switching circuit 124 goes back to S605. If the switching code is received through the spare line (YES at S606), the error detection-switching circuit 124 goes to S607.

At S607, the error detection-switching circuit 124 switches the data line through which the data on the bit identified by the switching bit information received after the switching code is transferred to the spare line. In other words, the error detection-switching circuit 124 receives the data on the bit identified by the switching bit information through the spare line.

When the switching to the spare line is completed at S607, then at S608, the error detection-switching circuit 124 transmits the switching completion notification to the transmission LSI 110.

At S609, the reception LSI 120 completes the process of switching to the spare line.

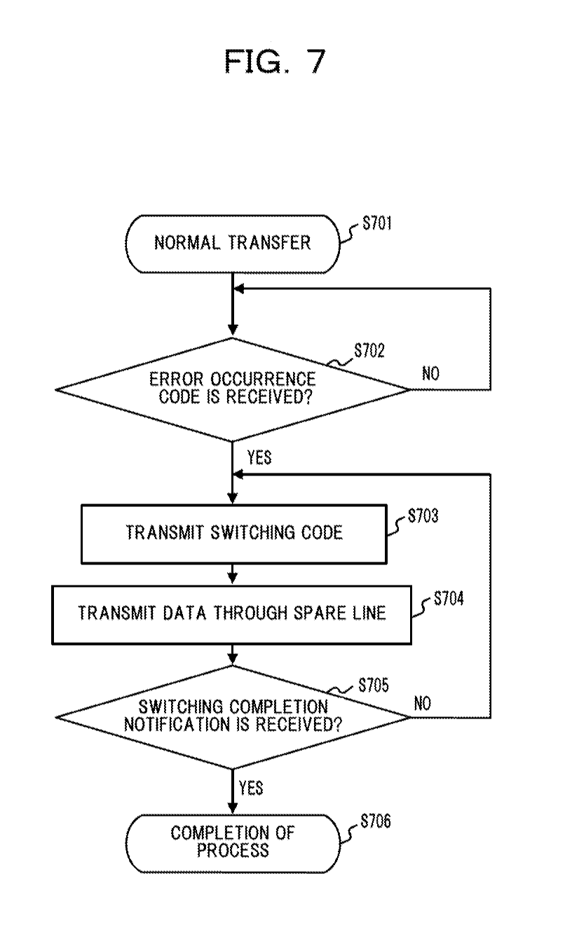

FIG. 7 is a flowchart illustrating an example of a process of switching to the spare line in the reception LSI 120 according to an embodiment. Referring to FIG. 7, for example, when the transmission LSI 110 and the reception LSI 120 are turned on, at S701, the transmission LSI 110 and the reception LSI 120 normally start the data transfer process between them.

At S702, the selection circuit 111 determines whether the error occurrence code transmitted from the error bit notification-switching determination circuit 125 is received through the error-bit information line.

If the error occurrence code is not received through the error-bit information line (NO at S702), the selection circuit 111 repeats S702. If the error occurrence code is received through the error-bit information line (YES at S702), the selection circuit 111 goes to S703.

At S703, the selection circuit 111 generates the switching code. Then, the selection circuit 111 transmits the generated switching code to the reception LSI 120 through the spare line.

In addition, the selection circuit 111 generates the switching bit information from the error bit information E received after the error occurrence code is received by the selection circuit 111. Then, the selection circuit 111 transmits the switching bit information to the reception LSI 120 through the spare line, subsequently to the switching code.

After the transmission of the switching code and the switching bit information is completed, at S704, the selection circuit 111 transmits the data on the bit position identified in the data D by the switching bit information to the reception LSI 120 through the spare line.

At substantially the same time, the selection circuit 111 transmits the data D to the reception LSI 120 through the data lines 0, 1, . . . , and N.

At S705, the selection circuit 111 determines whether the switching completion notification transmitted from the error bit notification-switching determination circuit 125 is received through the error-bit information line.

If the selection circuit 111 determines that the switching completion notification is not received through the error-bit information line (NO at S705), the selection circuit 111 goes back to S703. If the selection circuit 111 determines that the switching completion notification is received through the error-bit information line (YES at S705), the selection circuit 111 goes to S706. At S706, the transmission LSI 110 completes the process of switching to the spare line.

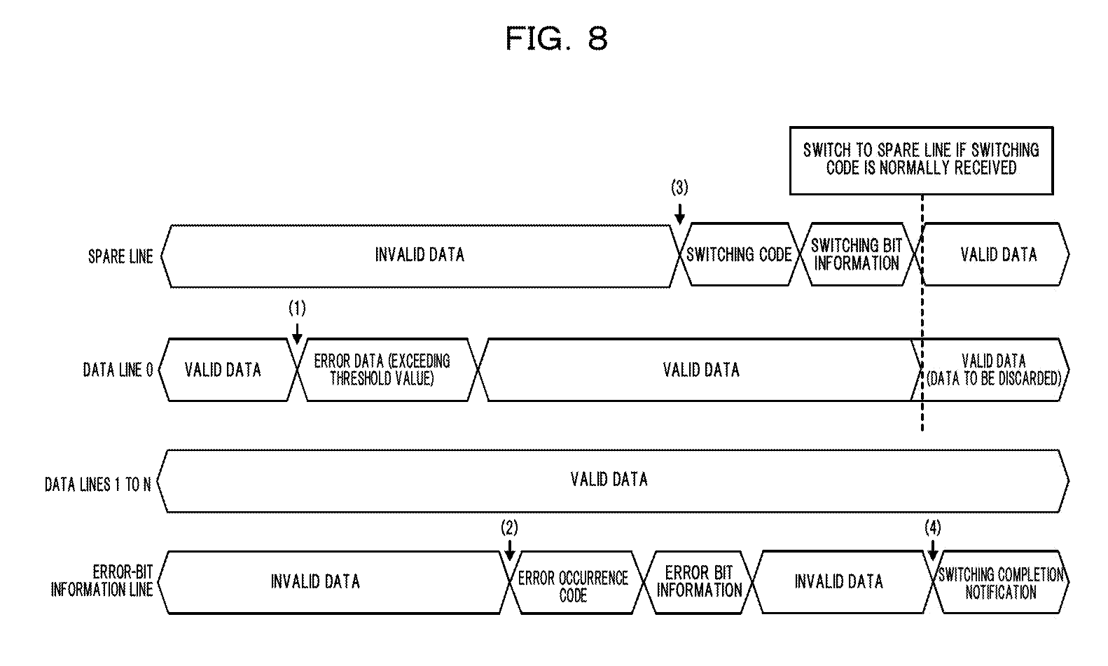

FIG. 8 is a time chart of the main signals when the number of error occurrences of transmission data D[0] transmitted from the transmission LSI 110 to the reception LSI 120 exceeds the line switching threshold value.

The signals transferred through the spare line, the data line 0, the data lines 1 to N, and the error-bit information line are illustrated in FIG. 8.

(1) If an error occurs in the data D[0] received through the data line 0, the error detection-switching circuit 124 detects the error in the data D[0]. The error detection-switching circuit 124 detects that the number of error occurrences at the bit 0 exceeds the threshold value.

(2) The error detection-switching circuit 124 transmits the error occurrence code and the error bit information E to the transmission LSI 110 through the error-bit information line.

(3) Upon the reception of the error occurrence code and the error bit information E, the selection circuit 111 switches the line of data D[0] at the bit 0 identified by the error bit information E to the spare line. Then, the selection circuit 111 transmits the switching code and the switching bit information to the reception LSI 120 through the spare line.

(4) Upon the reception of the switching code and the switching bit information through the spare line, the error detection-switching circuit 124 receives the data D[0] at the bit 0 identified by the switching bit information through the spare line. The error bit notification-switching determination circuit 125 transmits the switching completion notification to the transmission LSI 110 through the error-bit information line.

Only one spare line is used in the data transfer method described above for simplicity. However, the data transfer method is not limited to the use of only one spare line.

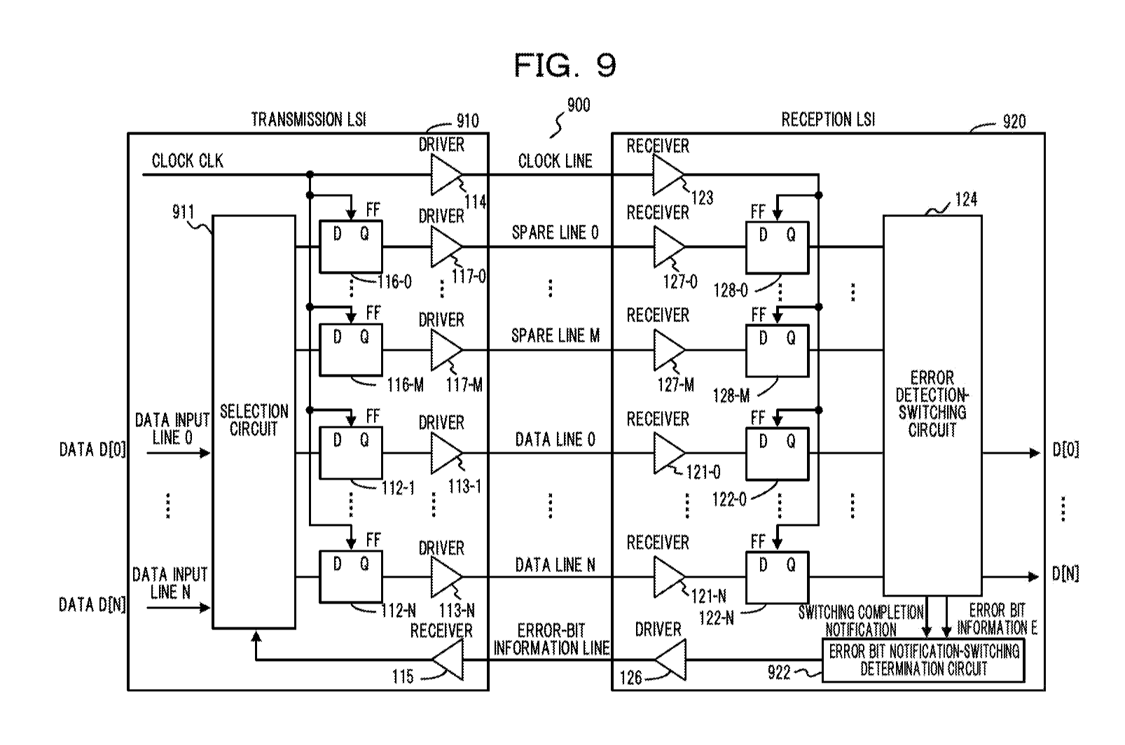

FIG. 9 illustrates a modification of the configuration realizing the data transfer method according to an embodiment.

Referring to FIG. 9, a data transfer system 900 includes a transmission LSI 910 and a reception LSI 920. The transmission LSI 910 is connected to the reception LSI 920 so as to be capable of communicating with the reception LSI 920 via data lines 0, 1, . . . , and N, spare lines 0, 1, . . . , and M, a clock line, and an error-bit information line. “M” denotes a natural number that is not smaller than one and is not larger than “N”.

The spare lines 0, 1, . . . , and M are provided for the spare for the data lines and are used to transmit one-bit-width data, respectively.

The transmission LSI 910 includes a selection circuit 911, FFs 112-0 to 112-N, drivers 113-0 to 113-N, a driver 114, a receiver 115, FFs 116-0 to 116-M, and drivers 117-0 to 117-M.

Part of the output terminal of the selection circuit 911 is connected to the FFs 116-0, 116-1, . . . , and 116-M.

The output terminals of the FFs 116-0, 116-1, . . . , and 116-M are connected to the drivers 117-0, 117-1, . . . , and 117-M, respectively.

The output terminals of the drivers 117-0, 117-1, . . . , and 117-M are connected to the spare lines 0, 1, . . . , and M, respectively.

The connection relationship between the other components is a similar to the one in the transmission LSI 110 illustrated in FIG. 1.

The reception LSI 920 includes receivers 121-0 to 121-N, FFs 122-0 to 122-N, a receiver 123, an error detection-switching circuit 921, an error bit notification-switching determination circuit 922, a driver 126, receivers 127-0 to 127-M, and FFs 128-0 to 128-M.

The receivers 127-0, 127-1, . . . , and 127-M are connected to the spare lines 0, 1, . . . , and M, respectively.

The output terminals of the receivers 127-0, 127-1, . . . , and 127-M are connected to the FFs 128-0, 128-1, . . . , and 128-M, respectively.

The output terminals of the FFs 128-0, 128-1, . . . , and 128-M are connected to the error detection-switching circuit 921.

The connection relationship between the other components is a similar to the one in the reception LSI 120 illustrated in FIG. 1.

In the above configuration, the transmission LSI 910 and the reception LSI 920 performs a process similar to the data transfer process illustrated in FIG. 1.

The error detection-switching circuit 921 determines whether an error occurs or occurred in the N+1-bit data D composed of the one-bit-width data D[0] to D[N]. If no error is detected, the error detection-switching circuit 921 outputs the data D of each bit to the data output lines 0, 1, . . . , and N.

If an error is detected, the error detection-switching circuit 921 generates the error bit information E and notifies the error bit notification-switching determination circuit 922 of the error bit information E.

Upon the reception of the notification of the error bit information E from the error detection-switching circuit 921, the error bit notification-switching determination circuit 922 counts the number of error occurrences at the error bit. For example, if an error has occurred in the data D[i], the error bit notification-switching determination circuit 922 counts and stores the number of error occurrences at the bit i.

If the number of error occurrences at the error bit i is larger than or equal to a predetermined value, the error bit notification-switching determination circuit 922 encodes the error bit information E into serial data and supplies the encoded error bit information E to the driver 126.

The driver 126 transmits the error bit information E to the receiver 115 through the error-bit information line. The receiver 115 supplies the error bit information E transmitted from the driver 126 to the selection circuit 911.

Upon the reception of the error bit information E from the receiver 115, the selection circuit 911 decodes the error bit information E in the serial data to identify the error bit i. Then, the selection circuit 911 switches the destination of the data D[i] at the error bit i from the FF 112-i to any of the FFs 116-0, 116-1, . . . , and 116-M. The FF that is set as the destination of the data D[i] is denoted by an FF 116-j, where “j” is a natural number that includes zero and is not larger than “M”. The same applies to the driver 117, the spare line, the receiver 127, the FF 128, the switching-signal selection circuit 202, and the selector 204 in the following description.

Here, the selection circuit 911 selects one of the FFs 116-0, 116-1, . . . , and 116-M, for example, in accordance with an predetermined order and outputs the data D[i] to the selected FF. In this case, the FFs that have been selected and used are excluded from the selection candidate.

At substantially the same time, the selection circuit 911 generates the switching bit information and supplies the switching bit information to the FF 116-j.

Then, the selection circuit 911 supplies the data D[0], D[1], . . . , and D[N] received from another LSI or the like to the FFs 112-0, 112-1, . . . , and 112-N, respectively. However, the selection circuit 911 supplies only the data D[i] to the FF 116-j.

The FF 116-j holds the switching bit information supplied from the selection circuit 911. The FF 116-j supplies the switching bit information to the driver 117-j in synchronization with the clock signal CLK. The driver 117-j transmits the switching bit information to the receiver 127-j through the spare line j.

Upon the reception of the switching bit information from the driver 117-j, the receiver 127-j supplies the switching bit information to the FF 128-j. The FF 128-j holds the switching bit information. The FF 128-j supplies the switching bit information to the error detection-switching circuit 921 in synchronization with the clock signal CLK supplied from the receiver 123.

The data D[i] is transmitted from the selection circuit 911 to the error detection-switching circuit 921 in a process similar to that for the switching bit information. The data D excluding the data D[i] is transferred in the manner described above.

Upon the reception of the switching bit information from the FF 128-j, the error detection-switching circuit 921 switches the data line i through which the data D[i] at the bit i identified by the switching bit information is transferred to the spare line j. Then, the error detection-switching circuit 921 supplies the switching completion notification to the error bit notification-switching determination circuit 922.

The error bit notification-switching determination circuit 922 supplies the received switching completion notification to the driver 126. The driver 126 transmits the switching completion notification to the receiver 115 through the error-bit information line.

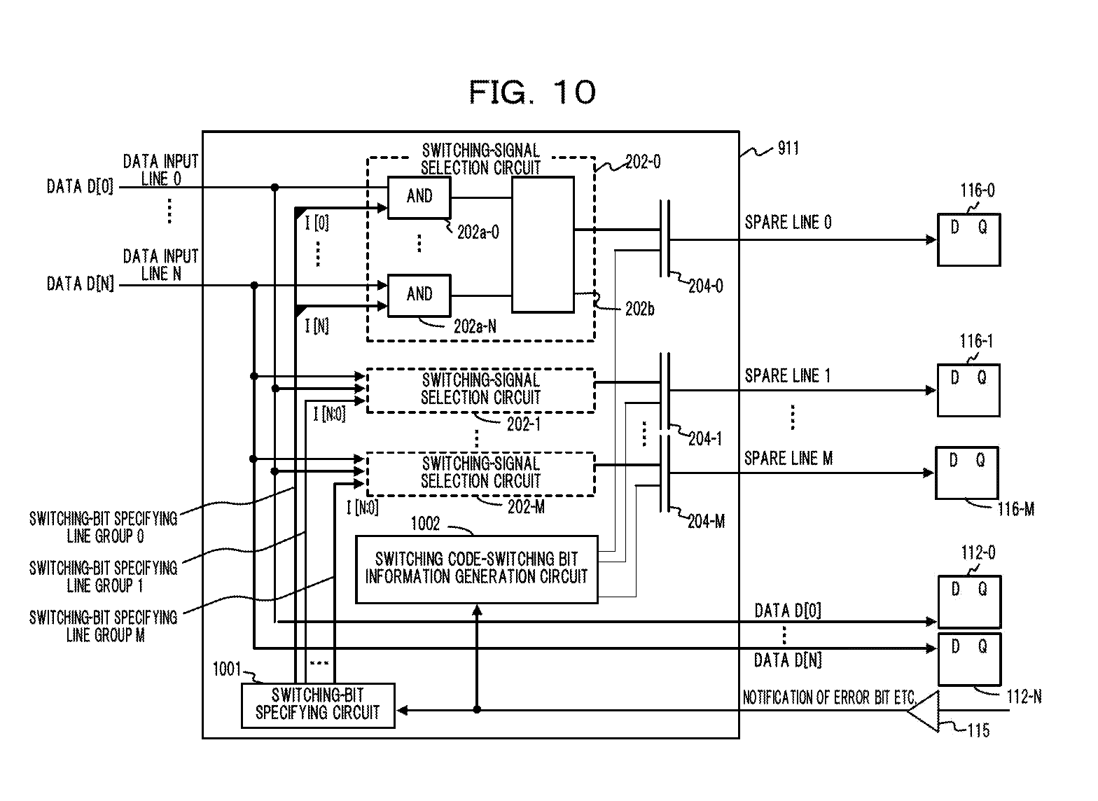

FIG. 10 illustrates a specific example of the configuration of the selection circuit 911 when a plurality of spare lines is used.

The selection circuit 911 includes a switching-bit specifying circuit 1001, switching-signal selection circuits 202-0, 202-1, . . . , and 202-M, a switching code-switching bit information generation circuit 1002, and selectors 204-0, 204-1, . . . , and 204-M.

The switching-signal selection circuits 202-0, 202-1, . . . , and 202-M each include AND circuits 202a-0, 202a-1, . . . , and 202a-N and an OR circuit 202b.

The switching-bit specifying circuit 1001, the switching-signal selection circuit 202-0, the switching code-switching bit information generation circuit 1002, and the selector 204-0 have substantially the same configuration as that of the switching-bit specifying circuit 201, the switching-signal selection circuit 202, the switching code-switching bit information generation circuit 203, and the selector 204 as illustrated in FIG. 2. In this case, a switching-bit specifying line group 0 is composed of the switching bit specifying lines 0 to N as illustrated in FIG. 2.

The same applies to the remaining switching-signal selection circuits 202-1, 202-2, . . . , and 202-M.

For example, the switching-bit specifying circuit 1001, the switching-signal selection circuit 202-M, the switching code-switching bit information generation circuit 1002, and the selector 204-M have substantially the same configuration as that of the switching-bit specifying circuit 201, the switching-signal selection circuit 202, the switching code-switching bit information generation circuit 203, and the selector 204 as illustrated in FIG. 2. In this case, a switching-bit specifying line group M is composed of the switching bit specifying lines 0 to N as illustrated in FIG. 2.

In the above configuration, when the switching-bit specifying circuit 1001 detects the error occurrence code, the switching-bit specifying circuit 1001 receives the error bit information E from the receiver 115 transmitted from the error bit notification-switching determination circuit 922 after the error occurrence code is transmitted.

Then, the switching-bit specifying circuit 1001 decodes the error bit information E transmitted as the serial data to identify the error bit. The switching-bit specifying circuit 1001 generates the switching-bit specifying data S.

The switching-bit specifying circuit 1001 selects the switching-signal selection circuit 202-j to which the switching-bit specifying data S is to be supplied from the switching-signal selection circuits 202-0 to 202-M in accordance with an predetermined order. The switching-bit specifying circuit 1001 supplies the switching-bit specifying data S to the selected switching-signal selection circuit 202-j.

The operation of the switching-signal selection circuit 202-j and the selector 204-j is substantially the same as that of the switching-signal selection circuit 202 and the selector 204 described above with reference to FIG. 2.

When the switching code-switching bit information generation circuit 1002 detects the error occurrence code, the switching code-switching bit information generation circuit 1002 receives the error bit information E which is transmitted from the error bit notification-switching determination circuit 922 after the error occurrence code, from the receiver 115.

Then, the switching code-switching bit information generation circuit 1002 decodes the error bit information E transmitted as the serial data to identify the error bit. The switching code-switching bit information generation circuit 1002 generates the switching bit information.

The switching code-switching bit information generation circuit 1002 selects the selector 204-j to which the switching bit information is to be supplied from the selectors 204-0 to 204-M in accordance with a predetermined order.

The switching code-switching bit information generation circuit 1002 generates the switching code and encodes the switching bit information into serial data. The switching code-switching bit information generation circuit 1002 supplies the switching code and the switching bit information to the selector 204-j. Here, the switching code-switching bit information generation circuit 1002 outputs the switching bit information after the switching code.

When the output signal is received from the switching code-switching bit information generation circuit 1002, the selector 204-j selects the output signal from the switching code-switching bit information generation circuit 1002 and supplies the selected output signal to the FF 116-j. When no output signal is received from the switching code-switching bit information generation circuit 1002, the selector 204-j supplies the output signal from the OR circuit 202b in the switching-signal selection circuit 202-j to the FF 116-j.

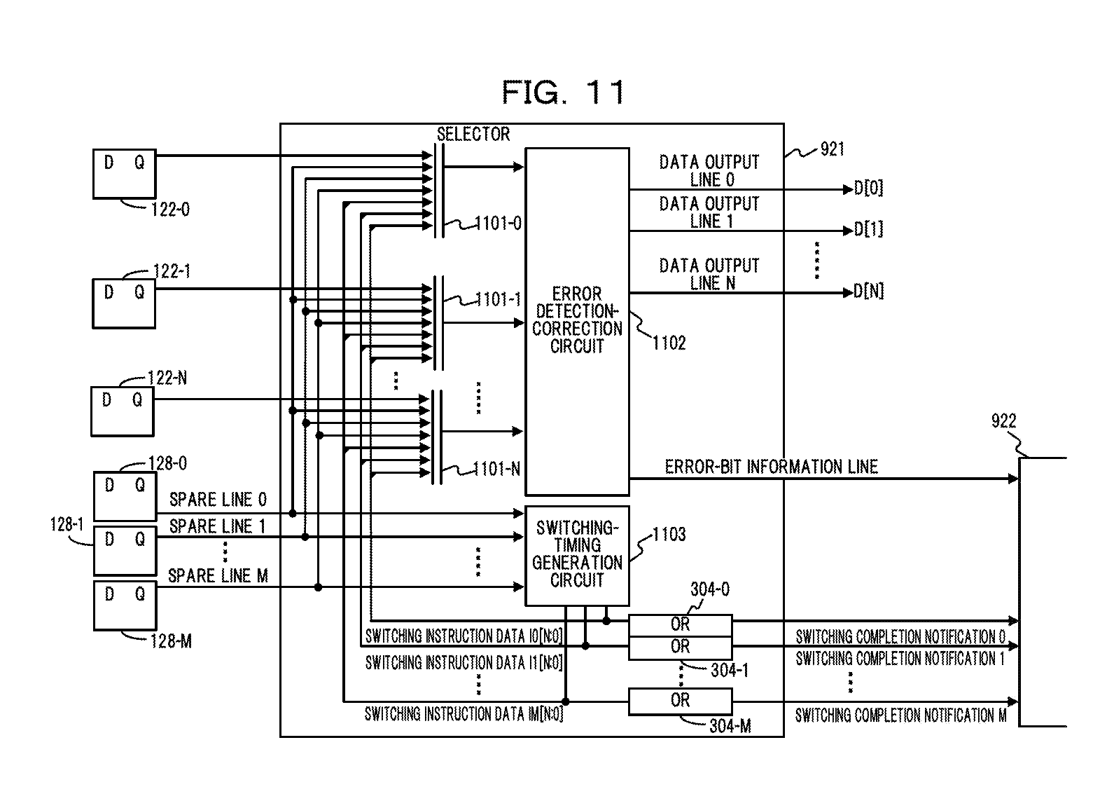

FIG. 11 illustrates a specific example of the configuration of the error detection-switching circuit 921 when a plurality of spare lines is used.

The error detection-switching circuit 921 includes selectors 1101-0 to 1101-N, an error detection-correction circuit 1102, a switching-timing generation circuit 1103, and OR circuits 304-0 to 304-M.

The output terminals of the FFs 122-0, 122-1, . . . , and 122-N are connected to the selectors 1101-0, 1101-2, . . . , and 1101-N, respectively.

The output terminal of the FF 128-0 is connected to the selectors 1101-0, 1101-1, . . . , and 1101-N and the switching-timing generation circuit 1103. The output terminals of the FFs 128-1, 128-2, . . . , and 128-M are also connected to the selectors 1101-0, 1101-1, . . . , and 1101-N and the switching-timing generation circuit 1103.

The output terminal of the switching-timing generation circuit 1103 is connected to the OR circuits 304-0, 304-1, . . . , and 304-M. The output terminals of the switching-timing generation circuit 1103, connected to the OR circuits 304-0, 304-1, . . . , and 304-M, are connected to the selectors 1101-0, 1101-1, . . . , and 1101-N, respectively.

For example, the output terminal of the switching-timing generation circuit 1103 connected to the OR circuit 304-0 also connects to the selectors 1101-0, 1101-1, . . . , and 1101-N. Here, one-bit-width data is transmitted through the lines connecting the switching-timing generation circuit 1103 to the selectors 1101-0, 1101-1, . . . , and 1101-N.

The output terminals of the selectors 1101-0, 1101-1, . . . , and 1101-N are connected to the error detection-correction circuit 1102.

Among the output terminals of the error detection-correction circuit 1102, the output terminals through which the data D is outputted connects to the data output lines 0, 1, . . . and N connected to the other LSI or the like (not illustrated). Among the output terminals of the error detection-correction circuit 1102, the error-bit information line through which the error bit information E is outputted connects to the error bit notification-switching determination circuit 922.

The output terminals of the OR circuit 304-0, 304-1, . . . , and 304-M are connected to the error bit notification-switching determination circuit 922.

In the above configuration, for example, the selector 1101-0 selects the output signal from the FF 128-j if the switching instruction data Ij[0], among the switching instruction data I0[0], I1[0], . . . , and IM[0] output from the switching-timing generation circuit 1103 which is set to “1”. The selector 1101-0 selects the output signal from the FF 122-0 if the switching instruction data I0[0], I1[0], . . . , and IM[0] are set to “0”, respectively. The selector 1101-0 supplies the selected signal to the error detection-correction circuit 1102.

The remaining selectors 1101-1, 1101-2, . . . , and 1101-N perform similar operations. For example, the selector 1101-N selects the output signal from the FF 128-j if the switching instruction data Ij[N] among the switching instruction data I0[N], I1[N], . . . , and IM[N] output from the switching-timing generation circuit 1103 is set to “1”. The selector 1101-N selects the output signal from the FF 122-N if the switching instruction data I0[N], I1[N], . . . , and IM[N] are set to “0”, respectively. The selector 1101-N supplies the selected signal to the error detection-correction circuit 1102.

The error detection-correction circuit 1102 receives the data D[0], D[1], . . . , and D[N] supplied from the selectors 1101-0, 1101-1, . . . , and 101-N, respectively. The error detection-correction circuit 1102 performs the error checking process on the N+1-bit-width data D composed of the data D[0], D[1], . . . , and D[N].

If no error is detected, the error detection-correction circuit 1102 supplies the data D of each bit to the data output lines 0, 1, . . . , and N. If an error is detected, the error detection-correction circuit 1102 generates the error bit information E.

After generating the error bit information E, the error detection-correction circuit 1102 supplies the error bit information E to the error bit notification-switching determination circuit 922.

If the switching-timing generation circuit 1103 detects the switching code from the output signal from the FF 128-0, the switching-timing generation circuit 1103 acquires the switching bit information transmitted after the switching code. Then, the switching-timing generation circuit 1103 generates the switching instruction data I0. The switching instruction data I0 is similar to the switching instruction data I described above with reference to FIG. 3.

After generating the switching instruction data I0, the switching-timing generation circuit 1103 supplies the switching instruction data I0 of each bit to the selectors 1101-0, 1101-1, . . . , and 1101-N. For example, the switching-timing generation circuit 1103 supplies the switching instruction data I0[0] to the selector 1101-0. Similarly, the switching-timing generation circuit 1103 supplies the switching instruction data I0[N] to the selector 1101-N, respectively.

The switching-timing generation circuit 1103 generates the switching instruction data I1, . . . , and IM in a similar process. Then, the switching-timing generation circuit 1103 supplies the switching instruction data I1, . . . , and IM of each bit to the selectors 1101-0, 1101-1, . . . , and 1101-N, respectively.

In addition, the switching-timing generation circuit 1103 supplies the switching instruction data I0, the switching instruction data I1, . . . , and the switching instruction data IM to the OR circuits 304-0, 304-1, . . . , and 304-M, respectively.

For example, the OR circuit 304-0 supplies a result of the logical OR operation of the data I0[0], I0[1], . . . , and I0[N] composing the switching instruction data I0 to the error bit notification-switching determination circuit 922. Similarly, the OR circuit 304-M supplies a result of the logical OR operation of the data IM[0], IM[1], . . . , and IM[N] composing the switching instruction data IM to the error bit notification-switching determination circuit 922.

A result of the logical OR operation output from the OR circuits 304-0, 304-1, . . . , and 304-M is used as a signal of a “switching completion notification”.

Since the error bit notification-switching determination circuit 922 has a configuration similar to that of the error bit notification-switching determination circuit 125 illustrated in FIG. 4, a detailed description of the error bit notification-switching determination circuit 922 is omitted herein. However, the output terminals of the OR circuits 304-0, 304-1, . . . , and 304-M in the error detection-switching circuit 921 are connected to the selector 404. Upon the reception of the output signals from the OR circuits 304-0, 304-1, . . . , and 304-M, the selector 404 selects one of the received output signals and supplies the selected output signal to the driver 126.

As described above, the data transfer system 100 includes the spare line, in addition to the data lines 0, 1, . . . , and N, the clock line, and the error-bit information line.

The reception LSI 120 counts the number of error occurrences in the received data D for every bit. The reception LSI 120 notifies the transmission LSI 110 of the error bit information if the number of error occurrences is larger than or equal to the line switching threshold value. The transmission LSI 110 switches the destination of the data on the error bit identified by the received error bit information to the spare line.

As a result, for example, even if a fixed error occurs in one of the data lines or errors frequently occur, it is possible to recover to the normal data transfer process.

One-bit-width data is transmitted through the spare line in the data transfer system 100, and only one spare line is provided in the data transfer system 100. Accordingly, the redundant signal wiring can be minimized. In addition, an increase in the manufacturing cost may be suppressed.

As described above, with the data transfer system 100, it is possible to improve the reliability of the data transfer process with minimized redundant signal wiring.

The data transfer system 900 includes the spare lines 0, 1, . . . , and M, in addition to the data lines 0, 1, . . . , and N, the clock line, and the error-bit information line.

The reception LSI 920 counts the number of error occurrences in the received data D for every bit. The reception LSI 920 notifies the transmission LSI 910 of the error bit information if the number of error occurrences is larger than or equal to the line switching threshold value. The transmission LSI 910 selects the spare line j from the spare lines 0, 1, . . . , and M and switches the destination of the data on the error bit identified by the received error bit information to the spare line j.

As a result, advantages similar to those in the data transfer system 100 are offered.

Furthermore, since the data transfer system 900 include the M-number spare lines, it is possible to recover to the normal transfer process even if fixed errors occur in two or more lines in the data lines.

All examples and conditional language recited herein are intended for pedagogical objects to aid the reader in understanding the invention and the concepts contributed by the inventor to furthering the art, and are to be construed as being without limitation to such specifically recited examples and conditions. Although the embodiment(s) of the present inventions have been described in detail, it should be understood that the various changes, substitutions, and alterations could be made hereto without departing from the spirit and scope of the invention.

What is claimed is:

1. A data transfer system transmitting and receiving data through a first transmission path and a second transmission path, the data transferring system comprising:
a first apparatus that transmits data through the first transmission path connecting to the first apparatus; and
a second apparatus that receives the data from the first apparatus through the first transmission path, the second apparatus transmits error bit information about the bit position of an error occurring in data received from the first apparatus when the second apparatus detects that an error occurs in the received data, wherein
when the first apparatus receives the error bit information from the second apparatus, the first apparatus transmits switching bit information concerning the bit position which is identified by the error bit information and the transmission path of which is switched to the second transmission path and the data on the bit position identified by the error bit information to the second apparatus through the second transmission path, and
the second apparatus receives the data on the bit position identified by the switching bit information through the second transmission path upon reception of the switching bit information from the first apparatus.

2. The data transfer system according to claim 1,
wherein the first apparatus includes
a transmission path switching part that identifies a transmission line in the first transmission path to be switched to the second transmission path based on the error bit information to transmit the data; and
a switching-bit-information transmitting part that generates the switching bit information from the error bit information and transmits the switching bit information to the second apparatus.

3. The data transfer system according to claim 2,
wherein the transmission path switching part identifies the transmission line in the first transmission path thorough which the data on the bit position identified by the error bit information is transmitted as the transmission line in the first transmission path to be switched to the second transmission path.

4. The data transfer system according to claim 2,
wherein the switching bit information generated by the switching-bit-information transmitting part is the information concerning the bit position identified by the error bit information.

5. The data transfer system according to claim 2,
wherein the switching-bit-information transmitting part transmits the switching bit information to the second apparatus through the second transmission path.

6. The data transfer system according to claim 1,
wherein the second apparatus includes
an error detection notifying part that determines whether an error has occurred in data transmitted from the first apparatus, and generates the error bit information and notifies the first apparatus of the generated error bit information if the number of error occurrences at the bit position where the error has occurred is larger than or equal to a predetermined value; and
a reception path switching part that switches the reception path so that the data on the bit position identified by the switching bit information is received through the second transmission path when the reception path switching part receives the switching bit information from the first apparatus.

7. The data transfer system according to claim 6,
wherein the reception path switching part receives the switching bit information from the first apparatus through the second transmission path.

8. The data transfer system according to claim 1,
wherein the second transmission path includes transmission lines of a number that is not smaller than two and that is smaller than the number of bits in the data, and
wherein the first apparatus selects one of the transmission lines in the second transmission path upon reception of the error bit information from the second apparatus and transmits the switching bit information and the data on the bit position identified by the error bit information to the second apparatus through the selected transmission line in the second transmission paths.

9. A data transmitting apparatus transmitting and receiving data to and from a connected apparatus through a first transmission path and a second transmission path, the data transmitting apparatus comprising:
a transmission path switching part that identifies a transmission line in the first transmission path to be switched to the second transmission path on the basis of error bit information concerning the bit position of an error occurring in data to transmit the data that has been transmitted through the an identified transmission line in the first transmission path through the second transmission path; and
a switching-bit-information transmitting part generating switching bit information concerning the bit position which is identified by the error bit information and the transmission path of which is to be switched to the second transmission path on the basis of the error bit information to transmit the switching bit information to the connected apparatus.

10. The data transmitting apparatus according to claim 9,
wherein the transmission path switching part identifies the transmission line in the first transmission path thorough which the data on the bit position identified by the error bit information is transmitted as the transmission line in the first transmission path to be switched to the second transmission path.

11. The data transmitting apparatus according to claim 9,
wherein the switching bit information generated by the switching-bit-information transmitting part is the information concerning the bit position identified by the error bit information.

12. The data transmitting apparatus according to claim 9,
wherein the switching-bit-information transmitting part transmits the switching bit information to the connected apparatus through the second transmission path.

13. The data transmitting apparatus according to claim 9,
wherein the second transmission path includes transmission lines of a number that is not smaller than two and that is smaller than the number of bits in the data, and
wherein the data transmitting apparatus selects one of the transmission lines in the second transmission path upon reception of the error bit information from the connected apparatus and transmits the switching bit information and the data on the bit position identified by the error bit information to the connected apparatus through the selected transmission line in the second transmission path.

14. A data receiving apparatus transmitting and receiving data to and from a connected apparatus through a first transmission path and a second transmission path, the data receiving apparatus comprising:
an error detection notifying part that determines whether an error has occurred in data transmitted from the connected apparatus and generates an error bit information concerning the bit position of the error occurring in the data and notifies the connected apparatus of the generated error bit information if the number of error occurrences at the bit position where an error has occurred is larger than or equal to a predetermined value; and
a reception path switching part that switches the reception path so that the data on the bit position identified by a switching bit information concerning the bit position which is identified by the error bit information and the transmission path of which is to be switched to the second transmission path is received through the second transmission path upon reception of the switching bit information from the connected apparatus.

15. The data receiving apparatus according to claim 14,
wherein the reception path switching part receives the switching bit information from the connected apparatus through the second transmission path.

16. The data receiving apparatus according to claim 14,
wherein the second transmission path includes transmission lines of a number that is not smaller than two and that is smaller than the number of bits in the data, and
wherein the data receiving apparatus receives the data on the bit position identified by switching bit information through the second transmission path used in the transmission of the switching bit information upon reception of the switching bit information from the connected apparatus.

17. A data transfer method transmitting and receiving data between a first apparatus and a second apparatus through a first transmission path that is between the first apparatus and the second apparatus and that includes a plurality of transmission lines and a second transmission path which is between the first apparatus and the second apparatus, the method comprising:
transmitting the data to the second apparatus through the first transmission path by the first apparatus;
receiving error bit information concerning the bit position of an error occurring in data received by the second apparatus from the second apparatus by the first apparatus; and
transmitting switching bit information and the data on the bit position identified by the error bit information to the second apparatus through the second transmission path by the first apparatus, the switching bit information concerning the bit position which is identified by the error bit information and the transmission path of which is to be switched to the second transmission path.

18. The data transfer method according to claim 17, further comprising:
detecting whether an error occurs in data transmitted from the first apparatus by the second apparatus;
notifying the first apparatus of the error bit information by the second apparatus; and
receiving the switching bit information and the data on the bit position identified by the switching bit information through the second transmission path by the second apparatus from the first apparatus.
